(19) United States
(12) Patent Application Publication
(10) Pub. No.: US 2020/0090263 A1
(43) Pub. Date: Mar. 19, 2020

(54) SYSTEM FOR MATCHING LENDERS AND BORROWERS

(71) Applicant: Catalina Baciu, Coquitlam (CA)

(72) Inventor: Catalina Baciu, Coquitlam (CA)

(21) Appl. No.: 16/132,145

(22) Filed: Sep. 14, 2018

(51) Int. Cl. G06Q 40/02; H04L 29/08

(52) U.S. Cl. CPC G06Q 40/025; H04L 67/306

(57) ABSTRACT

A system and method for identifying acceptable lenders for a borrower comprises receiving at a user interface a plurality of characteristics of the user, using the processor, identifying and selecting any accepting lender having a predetermined number of criteria corresponding to the plurality of characteristics for the accepting lender and presenting a list of acceptable lenders to the user. The identifying and selecting step may comprise matching each of the plurality of characteristics to a corresponding criteria of a plurality of criteria within a database operably coupled to the processor, the database containing a plurality of lenders each having the plurality of criteria, comparing a value for each of the plurality of characteristics against a required value for each of the corresponding criteria for each lender and selecting the accepting lenders from the database in which the predetermined number of characteristic matches the requirements for the corresponding criteria.

### BACKGROUND OF THE INVENTION

### 1. Field of Invention

The present invention relates generally to financing and in particular to a method and system for matching appropriate lenders to borrowers.

### 2. Description of Related Art

In the field of financing, it is frequently necessary to determine a suitable financing lender for a particular borrower. The process of identifying such suitable lenders is complicated by the fact that each lender may have different criteria as to the individuals and circumstances under which they are willing to loan money. This difficulty may be further complicated by the inclusion of both conventional financing lenders, such as banks, credit unions and the like as well as lenders who typically lend to borrowers with marginal or poor credit ratings, typically referred to as sub-prime lenders. It will be appreciated that sub-prime lenders may be known to require different information from borrowers as conventional lenders.

Conventionally, a borrower may be required to approach each lender they are aware of to inquire and then apply to borrow funds for their intended purpose. It will be appreciated that such process is time consuming and inefficient. It will also be appreciated that many potential borrowers will not be aware of all potential lenders and may therefore not apply to all available options.

Alternatively, some companies or organizations may include an individual or department intended to assist the borrower in locating a suitable lender. Examples of such organizations may be car dealerships, mortgage brokers or insurance companies. It will be appreciated that such departments or individuals will be required to be knowledgeable about all available lenders as well as the criteria for each lender which may be difficult where there are many potential lenders. It will further be appreciated that such brokers or individuals will still be required to apply to each potential lender directly to determine if such lender will accept the particular borrower applying. Such repetitive process is time consuming and difficult.

### SUMMARY OF THE INVENTION

According to a first embodiment of the present invention there is disclosed a method for identifying accepting lender for a comprising receiving at a user interface a plurality of characteristics of the user, using the processor, identifying and selecting any accepting lender having a predetermined number of criteria corresponding to the plurality of characteristics for the accepting lender and presenting a list of acceptable lenders to the user.

The identifying and selecting step may comprise utilizing the processor to match each of the plurality of characteristics to a corresponding criteria of a plurality of criteria within a database operably coupled to the processor, the database containing a plurality of lenders each having the plurality of criteria, utilizing the processor to compare a value for each of the plurality of characteristics against a required value for each of the corresponding criteria for each lender and selecting the accepting lenders from the database in which the predetermined number of characteristic matches the requirements for the corresponding criteria.

The method may further comprise transmitting the plurality of characteristics from the user interface to the processor across a network. The at least one of the plurality of characteristics may comprise binary data. The at least one of the plurality of characteristics may comprise numerical data. The required value for a particular lender may be satisfied when numerical data is equal to or above a predetermined threshold.

The processor may select the accepting lenders when a predetermined number of corresponding criteria is satisfied. At least one of the plurality of criteria for a potential may be a critical criteria wherein the processor rejects a potential lender when the critical criteria is not satisfied.

According to a further embodiment of the present invention there is disclosed a system for identifying accepting lender for a comprising a user input receiver operable to receive a plurality of characteristics of the user and a database containing a data representing a plurality of lenders each having a plurality of lending criteria. The system further comprises a processor configured to identify and select any accepting lender having a predetermined number of criteria corresponding to the plurality of characteristics for the accepting lender and an output adapted to presenting a list of the at acceptable lenders to the user.

The processor may further be adapted to match each of the plurality of characteristics to a corresponding criteria of a plurality of criteria within a database operably coupled to the processor, the database containing a plurality of lenders each having the plurality of criteria, compare a value for each of the plurality of characteristics against a required value for each of the corresponding criteria for each lender and select the accepting lenders from the database in which the predetermined number of characteristic matches the requirements for the corresponding criteria.

The system may further comprise a receiver in communication with the processor operable to receive the plurality of characteristics from the user interface transmitted across a network. The at least one of the plurality of characteristics may comprise binary data. The at least one of the plurality of characteristics may comprise numerical data. The required value for a particular lender may be satisfied when the numerical data is equal to or above a predetermined threshold.

The processor may be adapted to select the accepting lenders when a predetermined number of corresponding criteria is satisfied. At least one of the plurality of criteria for a potential may be a critical criteria wherein the processor is adapted to reject a potential lender when the critical criteria is not satisfied.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a system for use in identifying a list of suitable lenders for a particular borrower according to one embodiment of the present invention.

FIG. 2 is a schematic of the system of claim 1.

FIG. 3 is an illustration of a data table for use in the system of FIG. 1.

FIG. 4 is a flow chart of a method for identifying a list of potential lenders for a borrower utilizing the system of FIG. 1.

FIG. 5 is a screenshot of the data entry into the system of FIG. 1.

FIG. 6 is a screenshot of the output of potential lenders utilizing the system of FIG. 1.

### DETAILED DESCRIPTION

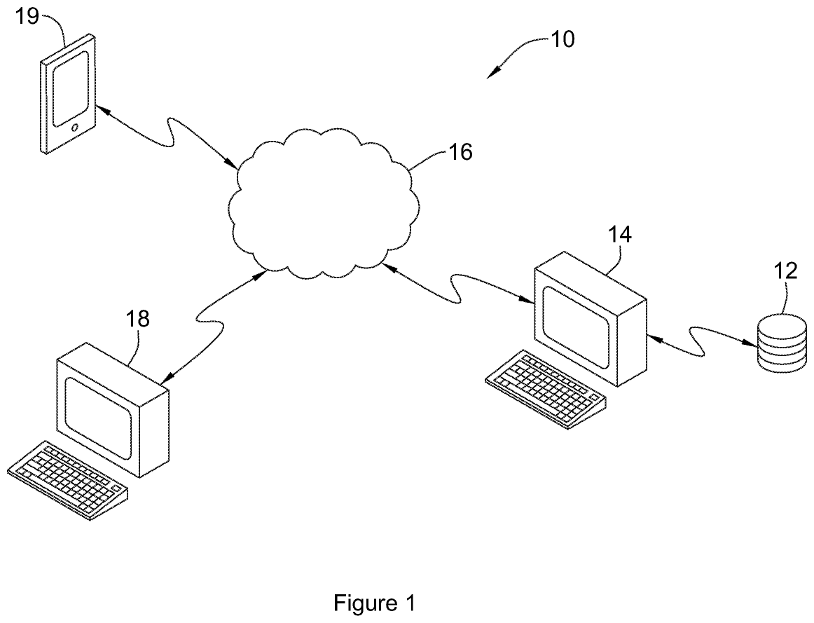

Referring to FIG. 1, a system for identifying a list of potential lenders for a borrower according to a first embodiment of the invention is shown generally at 10. The system comprises a database 12 containing information on a plurality of lenders which is connected to a processor 14. The processor is operable to receive user inputs either directly or through remote devices 18 and/or 20 to access the database 12 to identify lenders whose information is included in the database 12 matching the characteristics entered on the processor or remote device 18 or 19. The lenders included in the database 12 may optionally be divided into those lenders who have been pre-selected or matched to a particular broker so as to enable such broker to establish and maintain contacts which such smaller subset of potential lenders. Each lender may also be able to log into the database or provide updated information to an administrator of the database to update their information from time to time as is commonly known. It will be appreciated that the remote device 18 may be any type of commonly known laptop or desktop computer or that the remote device 19 may also be any commonly known mobile device such as, by way of non-limiting example a smartphone or PDA. It will be understood that the architecture herein is provided for example purposes only and does not limit the scope of the various implementations of the communication systems and methods.

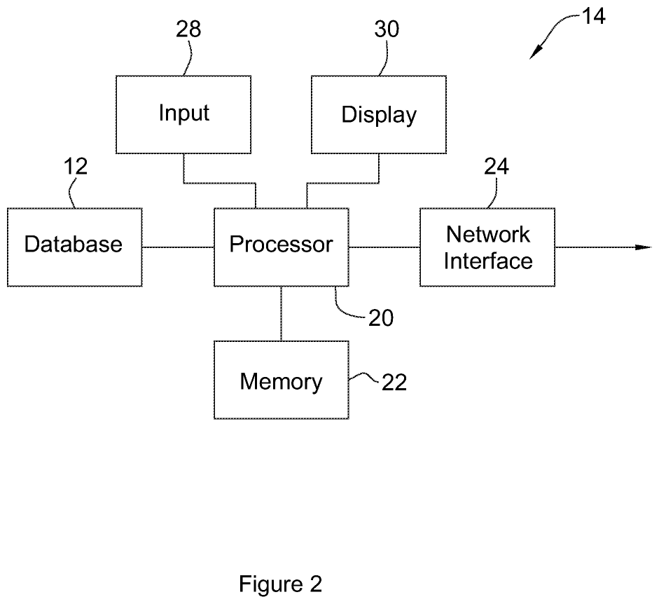

Turning now to FIG. 2, the processor 14 comprises a processing circuit 20, and memory 22 that stores machine instructions that when executed by the processing circuit 20, cause the processing circuit 20 to perform one or more of the operations and methods described herein. As illustrated in FIG. 1, the database 12 may be separate from the processor 14 although it will be appreciated that the database 12 may be contained within and a part of the processor 14. Processing circuit 20 may optionally contain a cache memory unit for temporary local storage of instructions, data, or computer addresses. The processor 14 may optionally include an input 28 and display 30 for receiving and displaying inputs from a database manager or user. As illustrated in FIG. 2, the processor 14 also includes a network interface 24 such as a radio transmitter, ethernet adapter or the like for providing communication between the processing circuit 20 and remote devices 18 and 19 as illustrated in FIG. 1.

More generally, in this specification, including the claims, the term “processing circuit ” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined by the claims appended hereto. In various embodiments, the processing circuit 20 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 22. In various embodiments, the processing circuit 20 can be implemented as a single-chip, multiple chips and/or other electrical components including one or more integrated circuits and printed circuit boards. The processing circuit 20 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 22 may include various tangible, non-transitory computer-readable media including Read-Only Memory (ROM) and/or Random-Access Memory (RAM). As is well known in the art, ROM acts to transfer data and instructions uni-directionally to the processing circuit 20, and RAM is used typically to transfer data and instructions in a bi-directional manner. In the various embodiments disclosed herein, RAM includes computer program instructions that when executed by the processing circuit 20 cause the processing circuit 20 to execute the program instructions described in greater detail below. More generally, the term “memory” as used herein encompasses one or more storage mediums and generally provides a place to store computer code (e.g., software and/or firmware) and data that are used by the user device 18. It may comprise, for example, electronic, optical, magnetic, or any other storage or transmission device capable of providing the processing circuit 20 with program instructions. Memory 22 may further include a floppy disk, CD-ROM, DVD, magnetic disk, memory chip, ASIC, FPGA, EEPROM, EPROM, flash memory, optical media, or any other suitable memory from which processing circuit 20 can read instructions in computer programming languages.

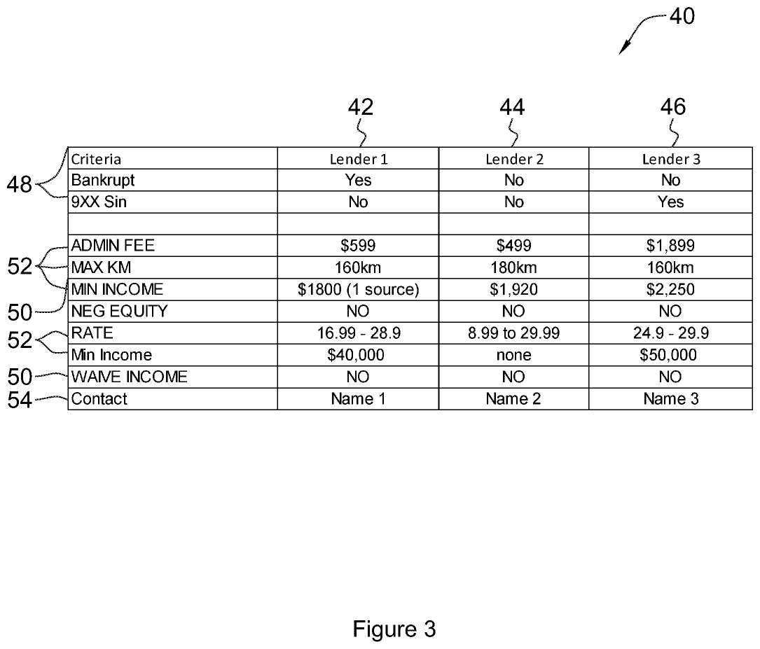

Turning now to FIG. 3, an illustration of the data contained within the database is generally illustrated at 40. The database 40 may contain a plurality of lenders 42, 44 and 46 each having values for a plurality of criteria and other information specific to that lender. In particular, some of the criteria may be binary data criteria 50 to which either a negative or positive response is required. Examples of some of such data may include, such as, by way of non-limiting example, whether the borrower has a 9xx sin number, whether the applicant has been bankrupt or had a vehicle repossessed or if the borrower is unemployed. In addition, some of such binary data criteria may also be designated as critical criteria 52 in which the lender will only be considered if the answer to all such criteria is positive. It will be appreciated that the critical criteria for any given lender may vary from lender to lender. Furthermore, the database may include numerical data criteria 52 for which the required answer for that lender is a minimum or maximum numerical value which the borrower characteristic must be either above or below as the case may be. Examples of such numerical data criteria may include such as, by way of non-limiting example, the income of the borrower, the value of the vehicle, the other expense of the borrower, acceptable service area of lenders, loan to value ratio, type of home or vehicle, age or illness condition of the borrower in the case of insurance. Furthermore, the database may include contact or other particular detail 54 of that lender to aid in contact and submission of data thereto. Examples of such particular data 54 may include, such as, by way of non-limiting example, contact person, phone number, address, fax, email address or any other specific information useful to assist applications and contact.

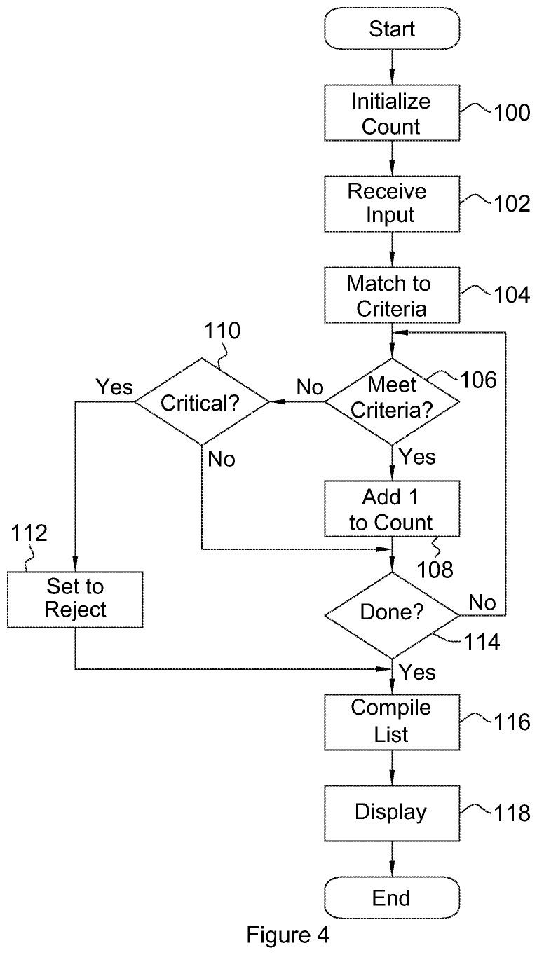

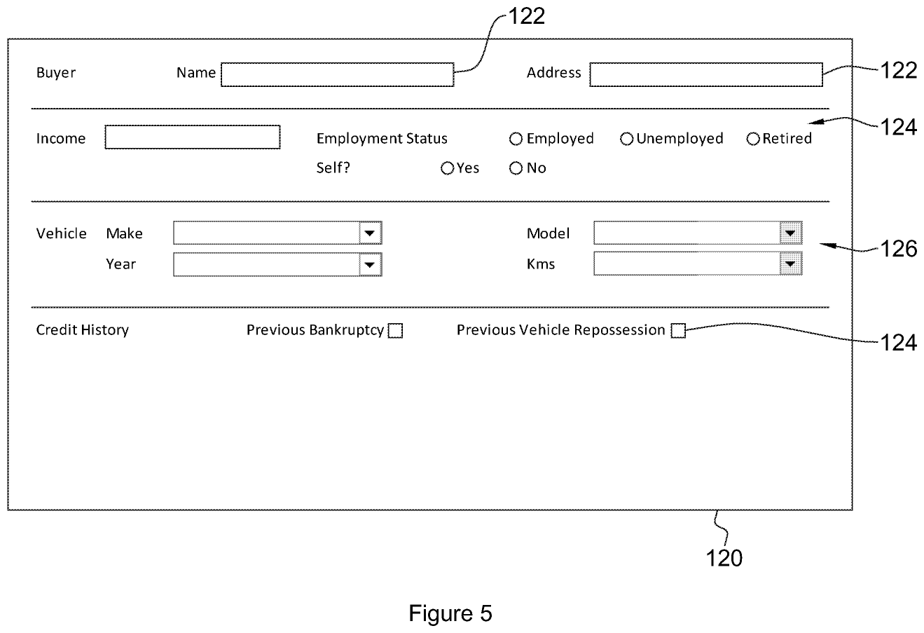

FIG. 4 is a flowchart depicting the actions taken on the user device 12. In step 100, the processing circuit first initializes the count for a lender that is being analysed. Thereafter in step 102, the system first receives an input from a borrower into either the processor 14 or remote device 18 or 19 as set out above. As illustrated in FIG. 5, the display screen of the processor 14 or remote device 18 or 19 may be divided into a plurality of fields corresponding to the criteria which is stored within the database 12 for the user to enter their information. Such data fields may accept typed in information 122, check boxes 124, pull-down menus 126 or any other data entry method as are commonly known. It will be appreciated that the input on the borrower entered into the field may be either submitted directly to the processing circuit 20 through any known means, or may optionally be transmitted to a third party intermediate as are commonly known in the art. The processing circuit 20 then matches each of the characteristics 122, 124 and 126 entered pertaining to the borrower which may be entered by the borrower or an agent for them to the corresponding criteria 48, 50 or 52 to ensure that the proper values are being assessed for each field. In step 104 the processing circuit 20 then compares the entered characteristic to the required answer for that criteria to determine if the criteria has been met in that case. By way of non-limiting example, where the answer is yes or no the processing circuit checks if the required response has been provided. Where the answer is a numerical answer, the processing circuit 20 check that the provided characteristic is above or below the required threshold as the case may be. If the criteria has been met in the processing circuit add 1 to the count and then checks if all criteria have been assessed in step 114. If the criteria has not been met, the processing circuit 20 checks if that criteria has been designated as critical in step 110. If that criteria has not been designated as critical the system proceeds to step 114 as set out above. If that criteria has been designated as critical, the processing circuit 20 sets that lender to reject this borrower in 112.

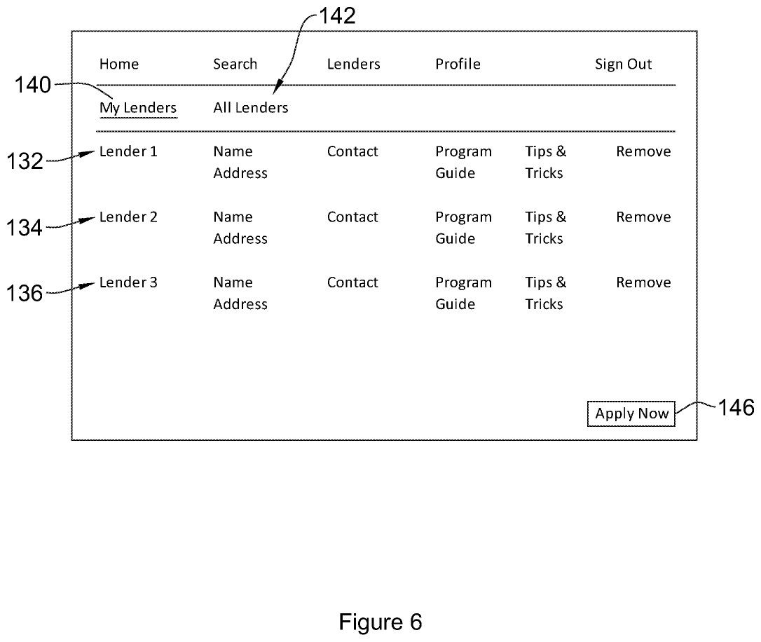

As illustrated in FIG. 4, the processing circuit checks each of the lenders in the database against the provided characteristics. Once all lenders have been assessed, the processing circuit 20 compiles a list of all lenders that would be suitable, or not rejected, as potential matches for the borrower. Optionally, the processing circuit 20 may only include those lenders having a required number of positive criteria as measured by their count as set out above. Thereafter, the system displays or otherwise presents the results to the user in step 118. It will be appreciated that the plurality lenders 132, 134 and 136 may be displayed to a user in a list of acceptable lenders 140 which are registered within the database 12 and linked with that broker on a user interface as illustrated in FIG. 6. Optionally, a list of other lenders 142 within the database which are not pre-selected or associated with that user or broker may also be provided to the broker or user. Such other lenders may provide an indication to the broker or user of the other options available to them which they may want to include in their pre-selected or otherwise associated with them. The list of acceptable lenders or other lenders may be organized according to any known criteria, such as most positive criteria, lowest offered interest rate or any other criteria. Optionally, the list of acceptable lenders may include a button 144 providing an ability for the user to apply to one or more of the acceptable lenders which will cause the processing circuit 20 to transmit the required information to the lenders for their consideration. The processing circuit 20 and database 12 may also be configured to track and record information on the deals approved and rejected by each lender so as to enable an operator or administrator to prepare a report summarizing the deals approved and characteristics approved by each lender.

While specific embodiments of the invention have been described and illustrated, such embodiments should be considered illustrative of the invention only and not as limiting the invention as construed in accordance with the accompanying claims.

What is claimed is:

1. A method for identifying acceptable lender for a comprising:
receiving at a user interface a plurality of characteristics of said user;
using said processor, identifying and selecting any accepting lender having a predetermined number of criteria corresponding to said plurality of characteristics for said accepting lender; and
presenting a list of acceptable lenders to said user.

2. The apparatus of claim 1 wherein said identifying and selecting step comprises:
utilizing said processor to match each of said plurality of characteristics to a corresponding criteria of a plurality of criteria within a database operably coupled to said processor, said database containing a plurality of lenders each having said plurality of criteria;
utilizing said processor to compare a value for each of said plurality of characteristics against a required value for each of said corresponding criteria for each lender; and
selecting said accepting lenders from said database in which said predetermined number of characteristic matches the requirements for said corresponding criteria.

3. The apparatus of claim 2 wherein said method further comprises transmitting said plurality of characteristics from said user interface to said processor across a network.

4. The apparatus of claim 2 wherein said at least one of said plurality of characteristics comprises binary data.

5. The apparatus of claim 2 wherein said at least one of said plurality of characteristics comprises numerical data.

6. The apparatus of claim 5 wherein said required value for a particular lender is satisfied when numerical data is equal to or above a predetermined threshold.

7. The apparatus of claim 2 wherein said processor selects said accepting lenders when a predetermined number of corresponding criteria is satisfied.

8. The apparatus of claim 2 wherein at least one of said plurality of criteria for a potential is a critical criteria wherein said processor rejects a potential lender when said critical criteria is not satisfied.

9. A system for identifying accepting lenders for a comprising:
a user input receiver operable to receive a plurality of characteristics of said user;
a database containing a data representing a plurality of lenders each having a plurality of lending criteria;
a processor configured to identify and select any accepting lender having a predetermined number of criteria corresponding to said plurality of characteristics for said accepting lender; and
an output adapted to presenting a list of said at acceptable lenders to said user.

10. The system of claim 9 wherein said processor is further adapted to:
match each of said plurality of characteristics to a corresponding criteria of a plurality of criteria within a database operably coupled to said processor, said database containing a plurality of lenders each having said plurality of criteria;
compare a value for each of said plurality of characteristics against a required value for each of said corresponding criteria for each lender; and
select said accepting lenders from said database in which said predetermined number of characteristic matches the requirements for said corresponding criteria.

11. The system of claim 10 further comprising a receiver in communication with said processor operable to receive said plurality of characteristics from said user interface transmitted across a network.

12. The system of claim 10 wherein said at least one of said plurality of characteristics comprises binary data.

13. The system of claim 10 wherein said at least one of said plurality of characteristics comprises numerical data.

14. The system of claim 13 wherein said required value for a particular lender is satisfied when numerical data is equal to or above said

15. The system of claim 10 wherein said processor is adapted to select said accepting lenders when a predetermined number of corresponding criteria is satisfied.

16. The system of claim 10 wherein at least one of said plurality of criteria for a potential is a critical criteria wherein said processor is adapted to reject a potential lender when said critical criteria is not satisfied.
